(19) United States
(12) Patent Application Publication
(10) Pub. No.: US 2005/0257695 A1
(43) Pub. Date: Nov. 24, 2005

(54) Transfer mechanism and product cart for particulate material

(76) Inventors: Miles Dobranski, Regina (CA); Serguei Naoumtchik, Regina (CA)

Correspondence Address: Ryan W. Dupuis;Ade & Company, 1700-360 Main Street, Winnipeg, MB, R3C 3Z3, CA

(21) Appl. No.: 11/193,504

(22) Filed: Aug. 1, 2005

(30) Foreign Application Priority Data
Jun. 13, 2003 (CA) 2,432,313

(51) Int. Cl. A23L 1/00

(52) U.S. Cl. 99/485

(57) ABSTRACT

A particulate material product cart uses a transfer mechanism for unloading particulate material from the cart. The cart includes a frame supporting an inlet hopper and a discharge chute thereon. The transfer mechanism includes a drum forming a plurality of radially divided product chambers. An inlet opening communicates between one of the product chambers and the inlet hopper and an outlet opening communicates between one of the product chambers and the discharge chute. Rotation of the drum transfers particulate material from the inlet hopper to the discharge chute with minimal disturbance of the product. The cart is particularly suited for handling pulse crops that require gentle handling to avoid crushing, for example beans, peas, lentils and the like.

### FIELD OF THE INVENTION

The present invention relates to a transfer mechanism for transferring particulate material, and more particularly relates to a transfer mechanism which is suited for use on a particulate material product cart, for example a grain cart and the like, for unloading the cart.

### BACKGROUND

Many mechanisms are known for handling and transferring particulate material product, in particular in the agricultural industry in which seed, grain, or fertilizer and the like are commonly handled and transported. Known handling equipment typically includes augers, grain carts and the like. A typical grain cart is supported on wheels and includes a tank for storing particulate material therein. Known grain carts typically employ an auger for discharging material stored therein, however the use of an auger in such an instance is known to crush certain pulse crops including beans, peas, lentils and the like.

### SUMMARY

According to a first aspect of the present invention there is provided a transfer mechanism for transferring particulate material, the mechanism comprising:

an inlet hopper for storing particulate material therein;

a discharge chute for discharging particulate material therefrom;

a drum including an outer peripheral wall and a plurality of radially extending divider walls forming a plurality of product chambers between respective adjacent ones of the divider walls;

a housing forming side walls for enclosing the product chambers of the drum, the housing including an inlet opening for communication between one of the product chambers and the inlet hopper and an outlet opening for communication between one of the product chambers and the discharge chute; and

driving means for driving rotation of the drum to transfer particulate material from the inlet hopper to the discharge chute.

According to a second aspect of the present invention there is provided a particulate material product cart comprising:

a frame supported for rolling movement along the ground;

an inlet hopper supported on the frame for storing particulate material therein;

a discharge chute for discharging particulate material therefrom;

a drum including an outer peripheral wall and a plurality of radially extending divider walls forming a plurality of product chambers between respective adjacent ones of the divider walls;

a housing forming side walls for enclosing the product chambers of the drum, the housing including an inlet opening for communication between one of the product chambers and the inlet hopper and an outlet opening for communication between one of the product chambers and the discharge chute; and

driving means for driving rotation of the drum to transfer particulate material from the inlet hopper to the discharge chute.

The use of a drum having chambers which rotate permits a large volume of material to be transferred at a high rate without aggressively handling or disturbing the product so that the product is exposed to low pressure to prevent crushing of gentler particulate materials including pulse crops such as beans, peas and lentils or the like. The use of such a transfer mechanism on a product cart is particularly useful for unloading the cart at a high rate while exposing the product to minimal damage.

In the transfer mechanism according to the present invention, the inlet opening and the outlet opening preferably communicate with diametrically opposed product chambers of the drum. When the drum rotates in an upright plane, the inlet opening preferably communicates with a lower one of the product chambers and the outlet opening preferably communicates with an upper one of the product chambers. Furthermore, the inlet opening and the outlet opening preferably communicate through the side walls on opposing sides of the drum.

When the drum lies at an upright incline and rotates about a drum axis at an offset inclination from horizontal, the inlet opening may communicate with an upward facing one of the side walls adjacent a bottom end of the housing and the outlet opening may communicate with an downward facing one of the side walls adjacent a top end of the housing.

When the housing is fixed in orientation and the drum is supported for rotation on the housing, the side walls of the housing are preferably lined with a material having a low coefficient of friction. The side walls of the housing in this arrangement, may be biased towards one another for snugly receiving the drum therebetween.

There may be provided a discharge conveyer in communication with the discharge chute in the form of a belt conveyor to further reduce possible damage to product being conveyed.

When the drum is supported in an upright orientation and there is provided an inner peripheral wall enclosing an inner end of each product chamber, the inner peripheral wall is preferably sloped radially inward in the axial direction towards the side wall locating the outlet opening therein.

### BRIEF DESCRIPTION OF THE DRAWINGS

In the accompanying drawings, which illustrate an exemplary embodiment of the present invention:

FIG. 1 is a front elevational view of a product cart including the transfer mechanism supported thereon.

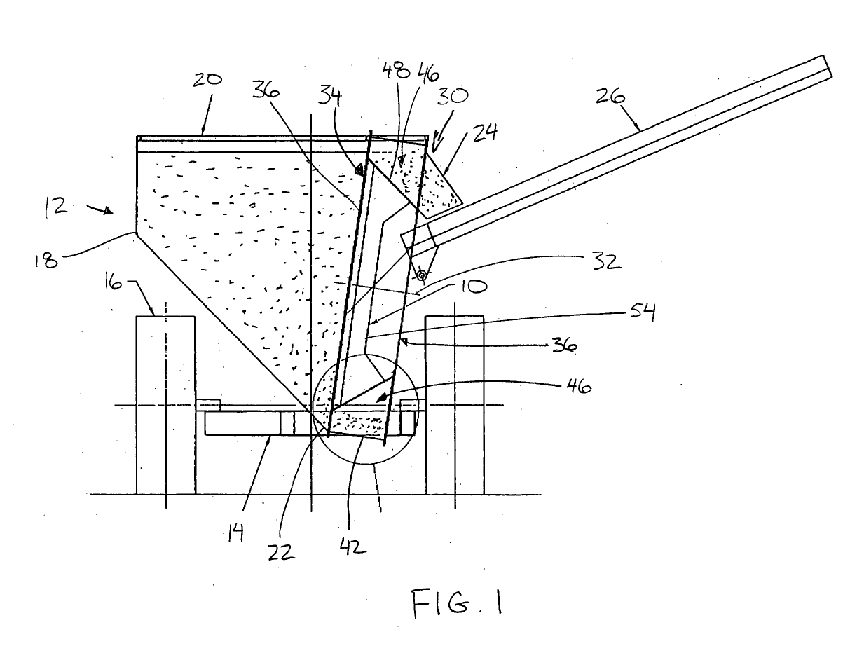

FIG. 2 is a top plan view of the cart and transfer mechanism.

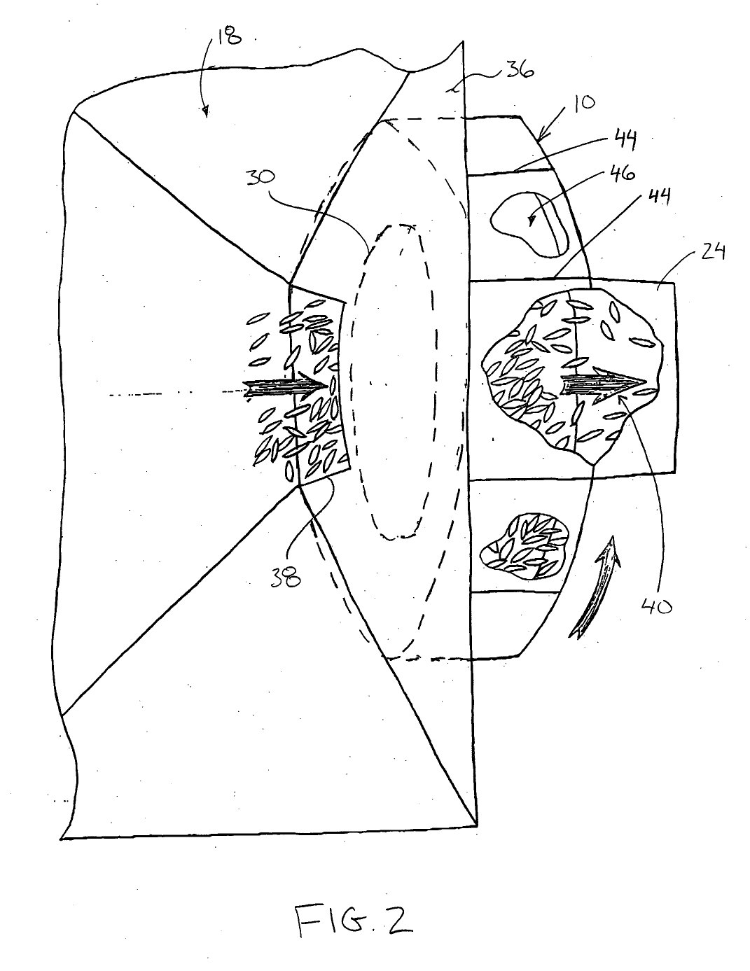

FIG. 3 is a side elevational view of the transfer mechanism.

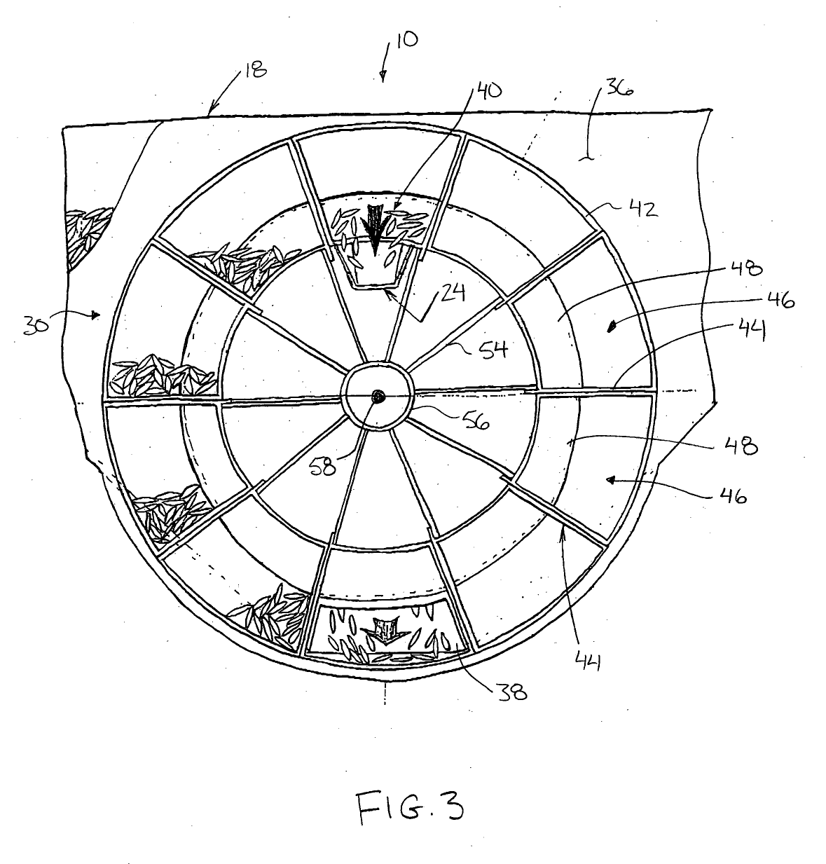

FIG. 4 is an enlarged sectional view of the inlet opening of the transfer mechanism.

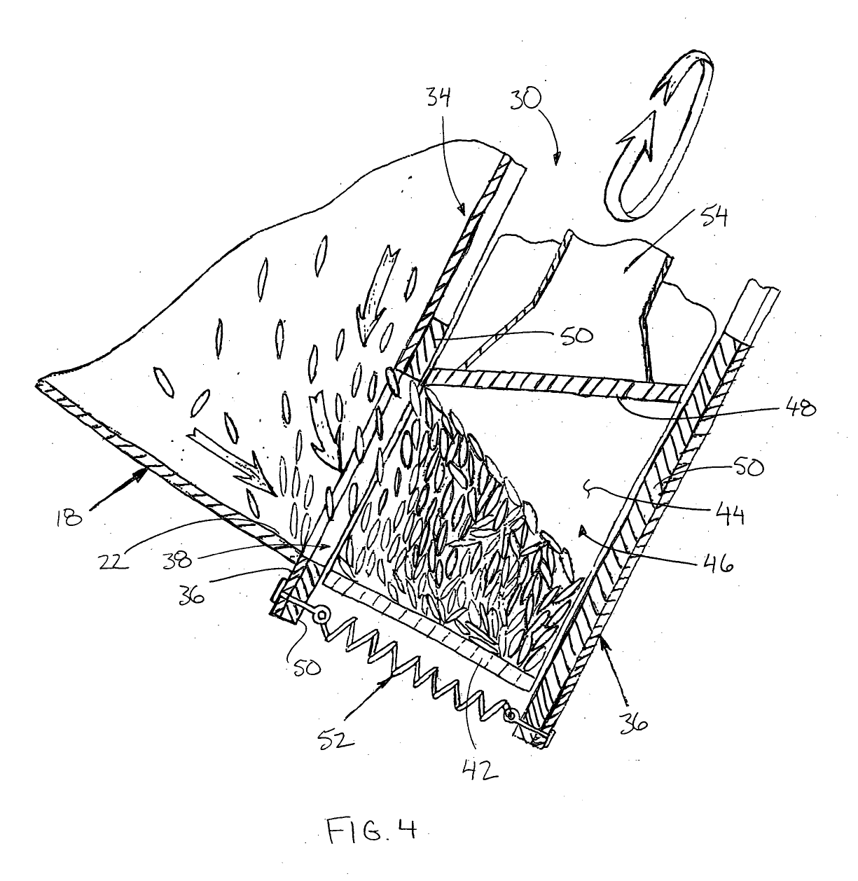

FIG. 5 is an enlarged sectional view of the outlet opening of the transfer mechanism.

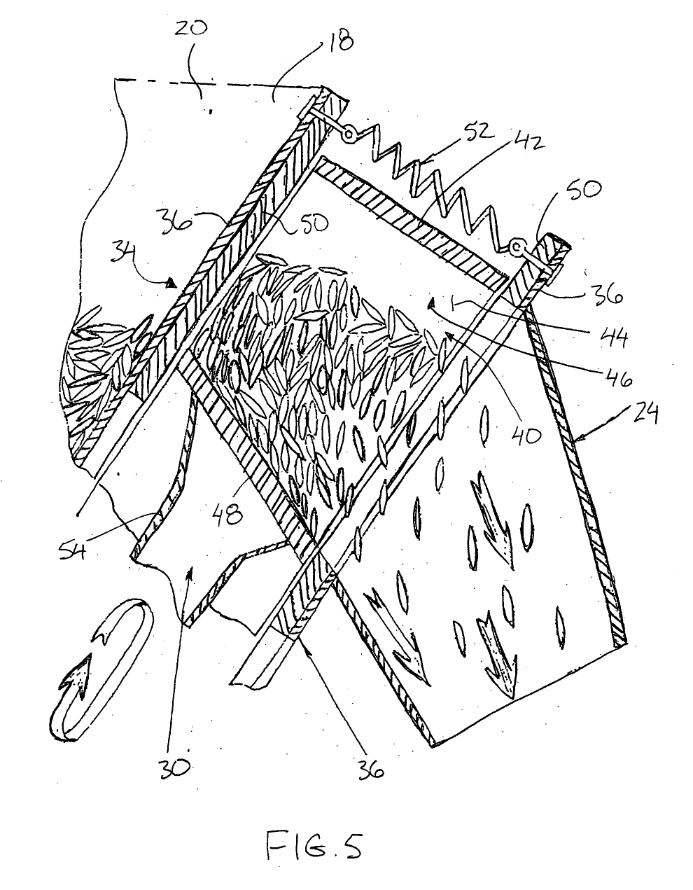

### DETAILED DESCRIPTION

Referring to the accompanying drawings, there is illustrated a transfer mechanism generally indicated by reference numeral 10. The transfer mechanism is particularly suited for use on a product cart 12 for carrying particulate material therein. The transfer mechanism is used to unload the cart and reduces damage to gentler crops including beans, peas and the like.

The cart includes a frame 14 which is supported on wheels 16 for rolling movement along the ground. The frame is arranged for towing by a suitable towing vehicle. A tank 18 is supported on the frame for storing particulate material therein. The tank is loaded through an open top end 20 and includes side walls which narrow and taper downwardly and inwardly to define an inlet hopper which discharges at bottom end 22 into the transfer mechanism 10. A discharge chute 24 is supported on a side of the cart adjacent the top end thereof in communication with the transfer mechanism to discharge particulate material from the transfer mechanism which has been collected at the bottom end of the tank 18. A discharge conveyor 26 in the form of a belt conveyor is mounted at the side of the cart below the discharge chute 24 so that material is discharged from the chute onto the belt of the conveyor 26. The conveyor 26 is supported on an adjustable frame which permits the conveyor to be pivoted and reoriented in relation to the cart.

The transfer mechanism 10 generally comprises a drum 30 which is supported for rotation about a drum axis 32 which is inclined from horizontal and oriented transversely to the forward towing direction of the cart. The drum is thus supported to lie in a generally upright plane of rotation positioned along one side of the cart to project upwardly and outwardly at a slight incline.

The transfer mechanism includes a housing 34 which is fixed in relation to the frame of the cart and forms a pair of parallel and opposed side walls of the drum 30. An inner one of the side walls 36 forms one of the side walls of the tank 18. An inlet opening 38 is formed in the inner side wall 36 adjacent the bottom end 22 of the tank. The inner side wall faces partially upward due to the upward and outward incline of the drums so that product in the tank is readily dispensed through the inlet opening into the interior of the drum 30.

An outlet opening 40 is formed in an outer one of the side walls 36 so as to be positioned on an opposite side wall from the inlet, diametrically opposed to the inlet at the top end of the drum. The outlet opening thus is formed in the side wall which faces partially downward and communicates with the drum at the highest point to readily permit product to be dispensed from the drum into the discharge chute 24 in communication with the outlet opening.

The drum 30 generally includes an outer peripheral wall 42 which is cylindrical in shape and which is bound on opposing sides by the side walls 36. A plurality of radially extending divider walls 44 are provided which divide the interior of the drum into a plurality of separate product chambers 46 in which each product chamber is defined between a respective adjacent pair of divider walls.

The drum further includes an inner peripheral wall 48 to enclose an inner end of each of the product chambers 46 such that the divider walls 44 span between the inner and outer peripheral walls 42 and 48. The inner peripheral wall 48 at the inner end of each product chamber is sloped to extend radially inwardly in the axial direction of the drum from the inner side wall supporting the inlet opening therein to the outer side wall supporting the outlet opening therein. Product contained within one of the product chambers that the uppermost point of rotation of the drum thus communicates that the outlet opening when the opening is aligned with the inner peripheral wall so that product is readily dispensed by the downward sloping nature of the inner peripheral wall into the discharge chute which subsequently dispenses the product onto the conveyor.

The side walls 36 of the housing include an interior lining 50 formed of a self-lubricating material having a low co-efficient of friction, for example high density plastics and the like or other materials commonly used in bearing components. The lining 50 only spans a portion of the side walls in communication with the product chambers about the outer periphery of the drum and is suitably dimensioned to span between the inner and outer peripheral walls. A plurality of tension springs 52 are connected between the opposed side walls 36 of the housing to bias the side walls towards one another to snugly and closely fit the drum therebetween.

A central portion of the drum is hollow and includes radiating spokes 54 which act as a support structure for supporting the walls of the drum on the central hub 56 rotatably supporting the drum on the frame of the cart. A suitable motor 58 is provided in communication with the hub 58 to drive rotation of the drum.

In use, the tank of the cart is loaded through the open top end thereof. When it is desirable to unload the material, the drum is rotated and the inlet opening 38 in the inner side wall of the housing adjacent the bottom end of the tank is ensured to be unobstructed such that any particulate material or product in the tank flows into a lowermost one of the chambers in communication with the inlet opening. The location of the inlet opening is fixed in the side wall of the housing such that continued rotation of the drum causes the product chambers to become enclosed between the side walls 36 of the housing until reaching the uppermost location at the top of the cart at which point the product chamber communicates with the outlet opening fixed in the outer side wall which faces partially downwardly to encourage product material to follow the slope of the inner peripheral wall to be deposited downwardly through the discharge chute onto the conveyor. The belt conveyor then carries the product to a target location to which the product is to be unloaded.

While one embodiment of the present invention has been described in the foregoing, it is to be understood that other embodiments are possible within the scope of the invention. The invention is to be considered limited solely by the scope of the appended claims.

1. A transfer mechanism for transferring particulate material, the mechanism comprising:
an inlet hopper for storing particulate material therein;
a discharge chute for discharging particulate material therefrom;
a drum including an outer peripheral wall and a plurality of radially extending divider walls forming a plurality of product chambers between respective adjacent ones of the divider walls;
a housing forming side walls for enclosing the product chambers of the drum, the housing including an inlet opening for communication between one of the product chambers and the inlet hopper and an outlet opening for communication between one of the product chambers and the discharge chute; and
driving means for driving rotation of the drum to transfer particulate material from the inlet hopper to the discharge chute.

2. The transfer mechanism according to claim 1 wherein the inlet opening and the outlet opening communicate with diametrically opposed product chambers of the drum.

3. The transfer mechanism according to claim 1 wherein the drum rotates in an upright plane.

4. The transfer mechanism according to claim 3 wherein the inlet opening communicates with a lower one of the product chambers.

5. The transfer mechanism according to claim 3 wherein the outlet opening communicates with an upper one of the product chambers.

6. The transfer mechanism according to claim 1 wherein the inlet opening and the outlet opening communicate through the side walls on opposing sides of the drum.

7. The transfer mechanism according to claim 6 wherein the drum lies at an upright incline and rotates about a drum axis at an offset inclination from horizontal, the inlet opening communicating with an upward facing one of the side walls adjacent a bottom end of the housing and the outlet opening communication with an downward facing one of the side walls adjacent a top end of the housing.

8. The transfer mechanism according to claim 1 wherein the housing is fixed in orientation, the drum being supported for rotation on the housing.

9. The transfer mechanism according to claim 8 wherein the side walls of the housing are lined with a material having a low coefficient of friction.

10. The transfer mechanism according to claim 8 wherein the side walls of the housing are biased towards one another for snugly receiving the drum therebetween.

11. A particulate material product cart comprising:
a frame supported for rolling movement along the ground;
an inlet hopper supported on the frame for storing particulate material therein;
a discharge chute for discharging particulate material therefrom;
a drum including an outer peripheral wall and a plurality of radially extending divider walls forming a plurality of product chambers between respective adjacent ones of the divider walls;
a housing forming side walls for enclosing the product chambers of the drum, the housing including an inlet opening for communication between one of the product chambers and the inlet hopper and an outlet opening for communication between one of the product chambers and the discharge chute; and
driving means for driving rotation of the drum to transfer particulate material from the inlet hopper to the discharge chute.

12. The cart according to claim 11 wherein the drum rotates in an upright plane.

13. The cart according to claim 12 wherein the inlet opening communicates with a lower one of the product chambers and the outlet opening communicates with an upper one of the product chambers, wherein the lower one of the product chambers and the upper one of the product chambers are substantially diametrically opposite one another.

14. The cart according to claim 11 wherein the inlet opening and the outlet opening communicate through the side walls on opposing sides of the drum.

15. The cart according to claim 14 wherein the drum lies at an upright incline and rotates about a drum axis at an offset inclination from horizontal, the inlet opening communicating with an upward facing one of the side walls adjacent a bottom end of the housing and the outlet opening communication with an downward facing one of the side walls adjacent a top end of the housing.

16. The cart according to claim 11 wherein the housing is fixed in orientation, the drum being supported for rotation on the housing and wherein the side walls of the housing are lined with a material having a low coefficient of friction.

17. The cart according to claim 11 wherein the housing is fixed in orientation, the drum being supported for rotation on the housing and wherein the side walls of the housing are biased towards one another for snugly receiving the drum therebetween.

18. The cart according to claim 11 wherein there is provided a discharge conveyer in communication with the discharge chute.

19. The cart according to claim 18 wherein the discharge conveyor comprises a belt conveyor.

20. The cart according to claim 11 wherein the drum is supported in an upright orientation and wherein there is provided an inner peripheral wall enclosing an inner end of each product chamber, the inner peripheral wall being sloped radially inward in the axial direction towards the side wall locating the outlet opening therein.
